(19) United States
(12) Patent Application Publication
(10) Pub. No.: US 2014/0341431 A1
(43) Pub. Date: Nov. 20, 2014

(54) PASSABLE SECURITY INSPECTION SYSTEM FOR PERSON

(71) Applicants: NUCTECH COMPANY LIMITED, Beijing (CN); TSINGHUA UNIVERSITY, Beijing (CN)

(72) Inventors: Zhiqiang Chen, Beijing (CN); Ziran Zhao, Beijing (CN); Wanlong Wu, Beijing (CN); Zhimin Zheng, Beijing (CN); Zongjun Shen, Beijing (CN); Xilei Luo, Beijing (CN); Shuo Cao, Beijing (CN); Yingkang Jin, Beijing (CN); Bin Sang, Beijing (CN)

(21) Appl. No.: 14/365,090

(22) PCT Filed: Nov. 27, 2012
(86) PCT No.: PCT/CN2012/085335

§ 371 Date: Jun. 12, 2014

(30) Foreign Application Priority Data
Dec. 16, 2011 (CN) 201110424156.9

(51) Int. Cl. G01V 8/00; G06K 9/62; G06K 9/20

(52) U.S. Cl. CPC G01V 8/005; G06K 9/209; G06K 9/6201
USPC 382/103

(57) ABSTRACT

The present invention discloses a through-type of millimetre wave person body security inspection system, wherein a person to be inspected passes through an inspect passage therein for performing a security inspection. The through-type of millimetre wave person body security inspection system provided in accordance with the present invention can make a total body dynamic scanning to the person to be inspected, and obtain millimetre wave images and optical images with respect to the person body, thereby achieving the inspection of prohibited articles hidden within clothing of the person body and an automatic alarm thereof.

### CROSS-REFERENCE TO RELATED APPLICATION

This application claims the benefit of Chinese Patent Application No. 201110424156.9 filed on Dec. 16, 2011 in the State Intellectual Property Office of China, the disclosure of which is incorporated herein by reference.

### BACKGROUND OF THE INVENTION

1. Field of the Invention

The present invention generally relates to a technical field of person body security inspection, in particular to a through-type of person body security inspection system, wherein millimetre wave images and optical images of a person body to be inspected are obtained from a total body scanning thereof, thereby achieving an inspection and an automatic alarm of prohibited articles hidden within clothing of the body.

2. Description of the Related Art

Common person security inspection apparatuses mainly include metal detectors, trace detectors, and X-ray transmission devices. In particular, the metal detector is sensitive only upon detecting metal substances; the trace detector is effective only to detect explosives and drugs, and the X-ray transmission devices can detect metal/non-metal articles, explosives, drugs or the like. The detection of the X-ray transmission device can have a higher space resolution and a certain scanning speed, but the use thereof in the person body security inspection is limited, since ionizing radiations of the X-rays are harmful to heath of the person body at a certain degree.

In order to effectively perform the person body security inspection, while ensuring that physical body of the person to be inspected would not be injured by the possible radiations, millimetre wave technology has been used in the technical field of the person body security inspection, as one advanced technique of the security inspection.

The security inspection made by the millimetre wave technology utilizes the millimetre waves to penetrate through the common clothing, however, each substance has different emissivity and reflection coefficient with respect to the millimetre waves (it is particularly true for the metal in contrast with other substances). The security inspection undergone by the millimetre wave technology is without any ionizing radiation, complicated radiation protection, and contact with the person body. Therefore, it is one ideal technology to perform the person body security inspection.

However, the current millimetre wave person body security inspection technology still exits the following drawbacks: (1) the millimetre wave imaging is largely affected by the conditions such as light illumination from the surrounding environment, high-temperature body, distribution of cold airs and air temperature; (2) the use of single millimetre wave imaging device causes inconvenience, and also reduces the passing rate, since the person to be inspected should turn around in site for cooperation with the inspection when it is used to make total body scanning from various angles; (3) because the dynamic millimetre wave images of the person body have complex forms, it cannot be directly used as criterion for determining whether to make an automatic alarm.

### SUMMARY OF THE INVENTION

An object of the present invention aims at addressing at least one aspect of problems and drawbacks existing in the prior art.

The present invention provides a through-type of millimetre wave person body security inspection system comprises:

an inspection passageway, configured for a person to be inspected to pass therethrough, so as to perform a security inspection;

a passive millimetre wave imaging device, configured to inspect the body of the person to be inspected passing through the inspection passageway and perform millimetre wave imaging;

an optical imaging device, configured to optically image the body inspected by the passive millimetre wave imaging device, corresponding to the passive millimetre wave imaging device;

a computer system, configure to process and compare the millimetre wave images and the optical images, thereby determining whether the person to be inspected carries prohibited articles.

Preferably, the passive millimetre wave imaging device comprises a first passive millimetre wave imaging device and a second passive millimetre wave imaging device, the first passive millimetre wave imaging device inspects a semi-perimeter of the body of the person to be inspected passing though the inspection passageway and making the millimetre wave imaging; the second passive millimetre wave imaging device inspects the other semi-perimeter of the body of the person to be inspected passing through the inspection passageway and making the millimetre wave imaging;

the optical imaging device comprises a first optical imaging device and a second optical imaging device, the first optical imaging device optically images a semi-perimeter of the body inspected by the first passive millimetre wave imaging device, corresponding to the first passive millimetre wave imaging device; the second optical imaging device optically images the other semi-perimeter of the body inspected by the second passive millimetre wave imaging device, corresponding to the second passive millimetre wave imaging device.

Preferably, the inspection passageway is a semi-enclosed inspection space.

Preferably, the inspection passageway is divided into a first inspection sub-passageway and a second inspection sub-passageway by a middle baffle plate, when the person to be inspected passes through the first inspection sub-passageway, the first passive millimetre wave imaging device and the first optical imaging device respectively perform the millimetre wave imaging and the optical imaging with respect to the person to be inspected; when the person to be inspected passes through the second inspection sub-passageway, the second passive millimetre wave imaging device and the second optical imaging device respectively perform the millimetre wave imaging and the optical imaging with respect to the person to be inspected, and the middle baffle plate is disposed so that the millimetre wave imaging and the optical imaging done with respect to the person to be inspected within the two inspection sub-passageways do not interfere with each other.

Preferably, the inspection passageway comprises an external wall body, a ceiling plate and a imaging device baffle plate.

Preferably, the external wall body comprises an outer layer, a supporting layer, a wave absorbing material layer and an inner layer.

Preferably, materials for the wave absorbing material layer are selected depending on working wave bands of the first and second passive millimetre wave imaging devices;

materials for the inner layer are transparent to the millimetre waves, or have low reflection coefficient to the millimetre waves.

Preferably, materials for the inner layer of the external wall body within the millimetre wave imaging zone are transparent to the millimetre waves.

Preferably, the ceiling plate has the same composition as that of the external wall body.

Preferably, the imaging device baffle plate comprises an outer layer, a supporting layer, an inner layer and an optical imaging window, wherein materials for the outer layer and the inner layer are transparent to the millimetre waves, and materials for the optical imaging window are transparent to visible lights.

Preferably, the middle baffle plate comprises a supporting layer and a coating layer, and materials for the supporting layer are transparent to the millimetre waves or have low reflection coefficient to the millimetre waves.

Preferably, the system further comprises an air temperature conditioning device disposed within the inspection passageway, which is configured to control temperature within the inspection passageway.

Preferably, the first optical imaging device is disposed above the first passive millimetre wave imaging device, the second optical imaging device is disposed above the second passive millimetre wave imaging device, the first optical imaging device has the same imaging scope as that of the first passive millimetre wave imaging device, and the second optical imaging device has the same imaging scope as that of the second passive millimetre wave imaging device.

Preferably, an illuminating device within the inspection passageway illuminates the inspection passageway by lights after diffusion.

Preferably, the system further comprises sensors respectively disposed at an entrance of the inspection passageway, a middle baffle plate of the inspection passageway, and an exit of the inspection passageway, which are configured to detect entry of the person to be inspected into the inspection passageway and leaving thereof away from the inspection passageway.

Preferably, the sensors are infrared sensor transmitters and infrared sensor receivers.

With the technical solutions provided by the present invention, at least one aspect of the following advantageously technical effect is/or are obtained: the use of the inspection passageway reduces negative effect of the surrounding environment to the millimetre wave image; the quality of the millimetre wave image is improved, especially, the semi-enclosed inspection passageway significantly eliminates the interference caused by the surrounding environment; since the person to be inspected passes through the inspection passageway on foot, the millimetre wave imaging devices finish the total body scanning to the person body from various angles, and the millimetre wave images and the optical images of the person body are dynamically displayed, so as to be convenient for observation and determination of the operator; the processing and comparison to the millimetre wave images and the optical images done by the computer system achieve the automatic detection and alarm to the prohibited articles within the body clothing.

### BRIEF DESCRIPTION OF THE DRAWINGS

These and other aspects as well as advantages of the present invention will become apparent and readily understood from the description of the preferred embodiments taking in conjunction with the accompanying drawings, in which:

FIG. 1 is a schematic view of a system in accordance with an embodiment of the present invention;

FIG. 2 is a schematic view of a structure of an external wall body of an inspection passageway in accordance with an embodiment of the present invention;

FIG. 3 is a view from a B direction as shown in FIG. 1 in accordance with an embodiment of the present invention, i.e., a schematic view of a structure of an imaging device baffle plate in the inspection passageway; and

FIG. 4 is a millimetre wave image and an optical image of a front face of a person to be inspected in accordance with an embodiment of the present invention.

### DETAILED DESCRIPTION OF THE EMBODIMENTS

Technical solutions of the present invention will be described hereinafter in more detail by the way of embodiment with reference to figures of the attached drawings, wherein the same or like reference numerals refer to the same or like elements throughout the specification. The explanation to the embodiment of the present invention with referring to the accompanying drawings is intended to interpret the general inventive concept of the present invention, rather than being construed as a limiting to the present invention.

A through-type of millimetre wave person body security inspection system in accordance with the present invention comprises: an inspection passageway 10, which is configured for a person to be inspected to pass through for performing a security inspection; a passive millimetre wave imaging device, which is configured to inspect a body of the person to be inspected passing through the inspection passageway and make millimetre wave imaging; an optical imaging device, which is configured to optically image the body to be inspected by the passive millimetre wave imaging device, corresponding to the passive millimetre imaging device; a computer system 40, which is configured to process and compare the obtained millimetre wave images and the obtained optical images, thereby determining whether the person to be detected carries prohibited articles.

Herein, it is possible to arrange the passive millimetre wave imaging device and the optical imaging device by various means, such as, the passive millimetre wave imaging device is disposed to include a plurality of passive millimetre wave sub-imaging devices; and accordingly, the optical imaging device is set to have a plurality of optical sub-imaging devices.

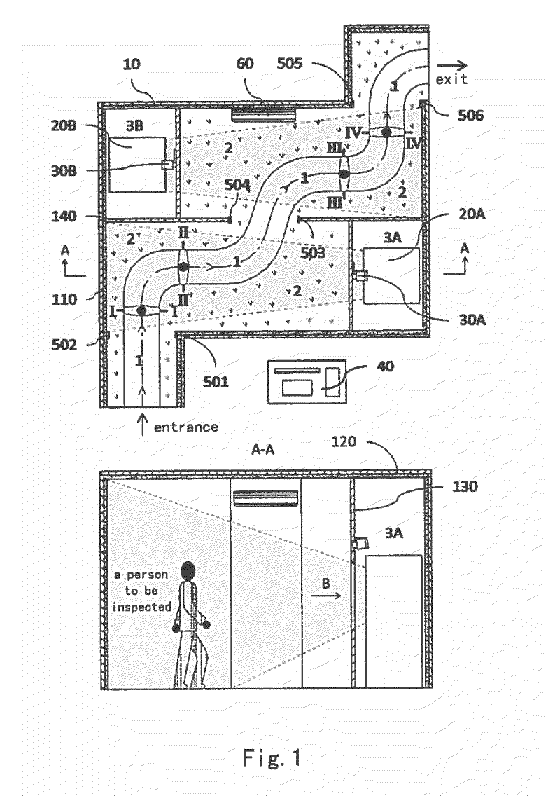

As shown in FIG. 1, in accordance with one preferred embodiment of the present invention, the passive millimetre wave imaging device can be set as a first passive millimetre wave imaging device 20A and a second passive millimetre wave imaging device 20B. As such, the optical imaging device includes a first optical imaging device 30A and a second optical imaging device 30B.

The first passive millimetre wave imaging device 20A is used to inspect a semi-perimeter of the person body to be inspected which passes through the inspection passageway and make millimetre wave imaging. The first optical imaging device 30A, corresponding to the first passive millimetre wave imaging device 20A, optically images the semi-perimeter of the inspected body by the first passive millimetre wave imaging device 20A. The second passive millimetre wave imaging device 20B is used to inspect the other semi-perimeter of the person body to be inspected which passes through the inspection passageway and make millimetre wave imaging. The second optical imaging device 30B, corresponding to the second passive millimetre wave imaging device 20B, optically images said the other semi-perimeter of the inspected body by the second passive millimetre wave imaging device 20B. The computer system 40 is used to process and compare the millimetre wave images and the optical images, thereby determining whether the person to be inspected carries the prohibited articles.

Specifically, the semi-perimeter and the other semi-perimeter referring to the body of the person to be inspected as described herein constitute a whole circular perimeter of the body, i.e., the whole body. In one specific embodiment, for example, a semi-perimeter of the body can be referred to span from a right side of the body to a front side thereof, while the other semi-perimeter of the body can be referred to span from a back side of the body to a left side thereof.

In a specific embodiment, preferably, the inspection passageway 10 is a semi-enclosed inspection space, thus improving an imaging quality of the millimetre wave imaging device, because interference to the imaging quality by millimetre waves generated by the surrounding environment is reduced minimally.

As shown in FIG. 1, in accordance with one preferred embodiment of the present invention, the inspection passageway is divided into a first inspection sub-passageway and a second inspection sub-passageway by a middle baffle plate 140. When the person to be inspected passes through the first inspection sub-passageway, the first passive millimetre wave imaging device 20A and the first optical imaging device 30A respectively perform the millimetre wave imaging and the optical imaging with respect to the person to be inspected. When the person to be inspected passes through the second inspection sub-passageway, the second passive millimetre wave imaging device 20B and the second optical imaging device 30B respectively perform the millimetre wave imaging and the optical imaging for the person to be inspected. The middle baffle plate is provided so that the millimetre wave imaging and the optical imaging for the person to be inspected carried out within the above two inspection sub-passageways respectively do not interference with each other.

In accordance with one preferred embodiment of the present invention, in order to improve inspection integrity of the person body to inspected, as shown in FIG. 1, an allowable pass area 1 for the person to be inspected to walk through on foot and a restricted pass area 2 are arranged within the inspection passageway. In other words, the person to be inspected only can pass through the allowable pass area 1 of the inspection passageway. Specifically, as shown in FIG. 1, the person to be inspected enters the inspection passageway from an entrance, passes through the pass area 1 of the inspection passageway and goes out of an exit. When the person to be inspected substantially goes on foot from a vicinity of I-I location of the passageway to a vicinity of II-II location of the passageway, the imaging of the body from the right side to the front side is done. When the person to be inspected substantially goes on foot from a vicinity of III-III location of the passageway to a vicinity of IV-IV location of the passageway, the imaging of the body from the back side to the left side is done. At this time, a total body dynamic scanning is completed. The automatic alarm about the prohibited articles within the clothing of the body can be achieved by processing and comparing the millimetre wave images and the optical images via the computer system 40.

In accordance with one preferred embodiment of the present invention, as shown in FIG. 1, the inspection passageway 10 includes an external wall body 110, a ceiling plate 120 and an imaging device baffle plate 130.

In accordance with an embodiment as shown in FIG. 1, the first passive millimetre wave imaging device 20A and the first optical imaging device 30A are provided within an imaging device placement zone 3A, which is defined by the external wall body 110, the middle baffle plate 140 and the imaging device baffle plate 130. The second passive millimetre wave imaging device 20B and the second optical imaging device 30B are provided within an imaging device placement zone 3B, which is defined by the external wall body 110, the middle baffle plate 140 and the imaging device baffle plate 130. Preferably, the first optical imaging device 30A is located above the first passive millimetre wave imaging device 20A, and the second optical imaging device 30B is located above the second passive millimetre wave imaging device 20B. The first optical imaging device 30A has the same imaging scope as that of the first passive millimetre wave imaging device 20A, whereas the second optical imaging device 30B has the same imaging scope as that of the second passive millimetre wave imaging device 20B.

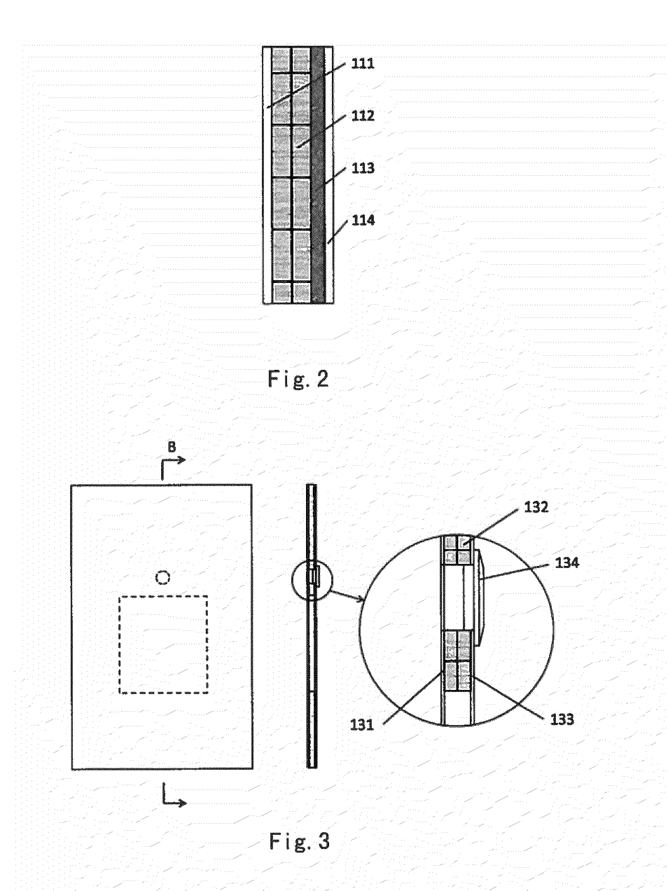

In accordance with the embodiment of the present invention, as shown in FIG. 2, the external wall body 110 includes an outer layer 111, a supporting layer 112, a wave absorbing material layer 113 and an inner layer 114.

The outer layer 111 and the supporting layer 112 only need to meet artistic and solid requirements, and the materials thereof are not limited. Materials for the wave absorbing material layer 113 should be selected depending on working wave band of the first and second passive millimetre wave imaging devices. The material of the inner layer 114 should be transparent to the millimetre waves or have low reflection coefficient for the millimetre waves, such as wood material; and the surface thereof should be rough or matt coating. In particular, it should be noted that the external wall body opposite to the imaging device is used as a backing plate for the millimetre wave imaging, and it demands the materials of the inner layer thereof are transparent to the millimetre waves, for example, cotton, linen or the like.

In accordance with the preferred embodiment of the present invention, the ceiling plate 120 has the same composition as that of the external wall body 110.

As shown in FIG. 3, the imaging device baffle plate includes an outer layer 131, a supporting layer 132, an inner layer 133 and an optical imaging window 134, wherein the materials for the outer layer and the inner layer are transparent to the millimetre waves, for example, cotton, linen or the like; and the material for the optical imaging window 134 is transparent to the visible light, for example, glasses, transparent organic glasses, transparent plastics or the like.

In accordance with one preferred embodiment of the present invention, the middle baffle plate 140 includes a supporting layer and a coating layer, wherein the material for the supporting layer is transparent to the millimetre waves or has low reflection coefficient for the millimetre waves, for example, wood materials, and the coating layer is of matt.

In addition, since one single image of a common millimetre wave imaging apparatus has a bright temperature resolution of 2K, if the temperature of the person body has little difference from the environment temperature, then it is impossible to obtain a brilliant millimetre wave image, and the person body would be “drowned” in the background. It can be found from experiments that a body surface temperature of the person body is approximately 35° C., and a temperature of ends of four limbs (i.e., arms and legs) is approximately 32° C. When the environment temperature is higher than 26° C., the millimetre wave image begins to become non-distinct. When the environment temperature is less than 24° C., the millimetre wave image is relatively ideal. Therefore, in order to improve the quality of the millimetre wave image of the person to be inspected, it is preferable to place an air temperature conditioner 60 (for example, air conditioner) in the inspection passageway, so as to control the temperature within the inspection passageway. It is beneficial to control the temperature thereof within a range of 22-24° C., and under such temperature the person body feels relative suitable, and the millimetre wave imaging has good effect so that it effectively distinguish the person body, the background, and the suspicious articles hidden behind the body surface.

In accordance with the preferred embodiment of the present invention, since it is necessary to optically image the person to be inspected, it demands light illumination having a sufficient lightness within the inspection passageway. However, because the millimetre wave imaging apparatus has particular requirements to the light illumination, i.e., not allowing to directly illuminate the backing plate and the millimetre wave imaging window, plaster of the ceiling plate is used on top of a lamp box, so that lights illuminate the person to be inspected only after though the diffusion.

In accordance with the preferred embodiment of the present invention, the system further includes a plurality of sensors respectively disposed within the entrance for the inspection passageway, the middle baffle plate, the exit for the inspection passageway, so as to detect entry of the person to be inspected into the inspection passageway and leaving of the person to be inspected away from the inspection passageway.

The sensors can be infrared sensor transmitters 501, 503, 505 and infrared sensor receivers 502, 504, 506.

In accordance with the preferred embodiment of the present invention, there are three ways to determine the person to be inspected within the inspection regions: (1) to automatically determine the person to be inspected within the inspection regions by obtaining the millimetre wave image or the optical image; (2) to respectively place the infrared sensors at the entrance of the inspection passageway, the middle baffle plate and the exit of the inspection passageway to achieve such purpose; and (3) to only respectively place the infrared sensors at the entrance and the exit of the inspection passageway, without the infrared sensor placed at the middle baffle plate of the inspection passageway. In the second case, as shown in FIG. 1, the infrared sensor transmitter 501 and the infrared sensor receiver 502 are placed at the entrance of the inspection passageway, the infrared sensor transmitter 503 and the infrared sensor receiver 504 are placed at the middle baffle plate of the inspection passageway, and the infrared sensor transmitter 505 and the infrared sensor receiver 506 are placed at the exit of the inspection passageway. The use of the above sensors can detect the position of the person to be inspected located in the inspection passageway.

In accordance with the preferred embodiment of the present invention, the passive millimetre wave imaging device inspects the prohibited articles hidden within the clothing of the person body, by means of the millimetre waves reflected by the person body. Therefore, the millimetre wave imaging device does not cause any ionizing radiation injury to the person body, can make a total body scanning to the body and has an imaging speed of 4 images per one second. An overlapping zone of the millimetre wave imaging scope (the shading area of FIG. 1) with the allowable passage area 1 is an effective imaging zone of the person body. When the person to be inspected goes though the inspection passageway on foot, the dynamic millimetre wave images of the person body are obtained, and information of the millimetre wave images is sent to the computer system so as to be processed and displayed. Meanwhile, the information of the optical images is also sent to the computer system so as to be processed and displayed.

The computer system used herein is commonly used in the processing field of the millimetre waves, which is composed of a control module, a communication module, a software module, an algorithm module and a display module. In particular, the control module takes in charge of interactive operations between the computer system and the operator, and retrieving a positional signal of the person to be inspected from a position sensor. The communication module takes in charge of the communication between the computer system and the passive millimetre wave imaging device, or the optical imaging device, or the control module. The software module takes in charge of systematic coordination. The algorithm module takes in charge of the image processing and comparison. The display module takes in charge of the display of the images, and alarm indication, or the like.

The processing and comparison of the millimetre wave images and the optical images done by the computer system achieve the automatic alarm to the prohibited articles within the clothing of the person body.

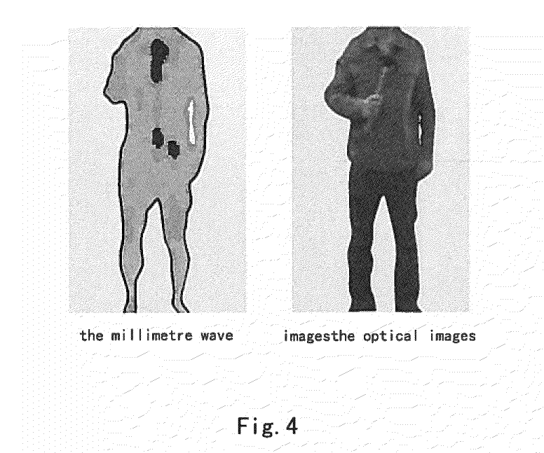

After the image processing of the millimetre wave images, such as noise removal, smoothing, background removal, stroking and contrast adjustment, the processed millimetre wave images are used to compare with the processed optical images, so as to find out different locations from the body profile in the optical image and recognize it as a suspicious area. The suspicious areas are marked in real time by a predetermined catchy colour (for example, bright red colour). FIG. 4 is a schematic view of the image processing and comparison, wherein the images are the millimetre wave image of the front side of the person to be inspected and the optical image synchronized therewith. The millimetre wave image is marked with a wood hammer having an iron head gripped by a hand and two suspicious articles hidden within the clothing.

In order to facilitate observation for the operator, it is also possible to perform a pseudo-colour processing with respect to the millimetre wave gray scale images without colours, and thus the images become more distinct from a visual viewpoint.

In addition, the inspection passageway has two operating modes, i.e., a single person operating mode and a double persons operating mode. Inspection efficiency in the double persons operating mode is double inspection efficiency in the single person operation mode. In the single person operating mode, a second person cannot enter the inspection passageway, until a first person entirely passes through the inspection passageway, the images of the first passive millimetre wave imaging device and the first optical imaging device are firstly displayed and the images of the second passive millimetre wave imaging device and the second optical imaging device are then displayed, and after completion of the inspection, the front and back images of the person to be inspected are displayed on the display screen at the same time. In the double person operating mode, after the first person goes out of the effective imaging zone of the firs passive millimetre wave imaging device and the first optical imaging device, and then enters the effective imaging zone of the second passive millimetre wave imaging device and the second optical imaging device, the second person can enter the inspection passageway. The images of the first passive millimetre wave imaging device and the first optical imaging device are firstly displayed and the images of the second passive millimetre wave imaging device and the second optical imaging device are then displayed, and after completion of the inspection, the front and back images of the person to be inspected are displayed on the display screen at the same time.

Since the millimetre wave image and the optical image need to be compared with each other, when installing the above two imaging devices, it should ensure that within the effective imaging scope, the images displayed on the display screen should have approximately the same size, while the two images should have the matched resolutions with each other.

The millimetre wave image has an imaging speed equal to or larger than 4 images per one second, and the optical image has an imaging speed equal to or larger than 20 images per one second; therefore, they are visually dynamic images. The walking speed of the person to be inspected is about 1 m/s, and thus it is possible to obtain at least 3 millimetre wave images within a 0.8 m scope in a front-back direction at four locations of I-I, II-II, IV-IV. It is possible for each millimetre wave image to find out an optical image which is substantially synchronous with it.

Although the present invention has been explained with reference to the drawings, the embodiments shown in the drawings are only illustrative, instead of limiting the present invention. It would be appreciated by those skilled in the art that modifications and variations may be made in these embodiments without departing from the principles and spirit of the general inventive concept of the disclosure, the scope of which is defined in the appended claims and their equivalents.

What the claims is:

1. A through-type of millimetre wave person body security inspection system comprises:
an inspection passageway, configured for a person to be inspected to pass therethrough, so as to perform a security inspection;
a passive millimetre wave imaging device, configured to inspect the body of the person to be inspected passing through the inspection passageway and perform millimetre wave imaging;
an optical imaging device, configured to optically image the body inspected by the passive millimetre wave imaging device, corresponding to the passive millimetre wave imaging device;
a computer system, configured to process and compare the millimetre wave images and the optical images, thereby determining whether the person to be inspected carries prohibited articles.

2. The system of claim 1, wherein the passive millimetre wave imaging device comprises a first passive millimetre wave imaging device and a second passive millimetre wave imaging device, the first passive millimetre wave imaging device inspects a semi-perimeter of the body of the person to be inspected passing through the inspection passageway and makes the millimetre wave imaging; the second passive millimetre wave imaging device inspects the other semi-perimeter of the body of the person to be inspected passing through the inspection passageway and makes the millimetre wave imaging;
the optical imaging device comprises a first optical imaging device and a second optical imaging device, the first optical imaging device optically images a semi-perimeter of the body inspected by the first passive millimetre wave imaging device, corresponding to the first passive millimetre wave imaging device; the second optical imaging device optically images the other semi-perimeter of the body inspected by the second passive millimetre wave imaging device, corresponding to the second passive millimetre wave imaging device.

3. The system of claim 1, wherein the inspection passageway is a semi-enclosed inspection space.

4. The system of claim 2, wherein the inspection passageway is divided into a first inspection sub-passageway and a second inspection sub-passageway by a middle baffle plate, when the person to be inspected passes through the first inspection sub-passageway, the first passive millimetre wave imaging device and the first optical imaging device respectively perform the millimetre wave imaging and the optical imaging with respect to the person to be inspected; when the person to be inspected passes through the second inspection sub-passageway, the second passive millimetre wave imaging device and the second optical imaging device respectively perform the millimetre wave imaging and the optical imaging with respect to the person to be inspected, and the middle baffle plate is disposed so that the millimetre wave imaging and the optical imaging done with respect to the person to be inspected within the two inspection sub-passageways do not interfere with each other.

5. The system of claim 3, wherein the inspection passageway comprises an external wall body, a ceiling plate and an imaging device baffle plate.

6. The system of claim 5, wherein the external wall body comprises an outer layer, a supporting layer, a wave absorbing material layer and an inner layer.

7. The system of claim 6, wherein materials for the wave absorbing material layer are selected depending on working wave bands of the first and second passive millimetre wave imaging devices;
materials for the inner layer are transparent to the millimetre waves, or have low reflection coefficient to the millimetre waves.

8. The system of claim 7, wherein materials for the inner layer of the external wall body within the millimetre wave imaging zone are transparent to the millimetre waves.

9. The system of claim 5, wherein the ceiling plate has the same composition as that of the external wall body.

10. The system of claim 5, wherein the imaging device baffle plate comprises an outer layer, a supporting layer, an inner layer and an optical imaging window, wherein materials for the outer layer and the inner layer are transparent to the millimetre waves, and materials for the optical imaging window are transparent to visible lights.

11. The system of claim 4, wherein the middle baffle plate comprises a supporting layer and a coating layer, and materials for the supporting layer are transparent to the millimetre waves or have low reflection coefficient to the millimetre waves.

12. The system of claim 1, further comprising an air temperature conditioning device disposed within the inspection passageway, which is configured to control temperature within the inspection passageway.

13. The system of claim 2, wherein the first optical imaging device is disposed above the first passive millimetre wave imaging device, the second optical imaging device is disposed above the second passive millimetre wave imaging device, the first optical imaging device has the same imaging scope as that of the first passive millimetre wave imaging device, and the second optical imaging device has the same imaging scope as that of the second passive millimetre wave imaging device.

14. The system of claim 1, wherein an illuminating device within the inspection passageway illuminates the inspection passageway by lights after diffusion.

15. The system of claim 1, further comprising sensors respectively disposed at an entrance of the inspection passageway, a middle baffle plate of the inspection passageway, and an exit of the inspection passageway, which are configured to detect entry of the person to be inspected into the inspection passageway and leaving thereof away from the inspection passageway.

16. The system of claim 15, wherein the sensors are infrared sensor transmitters and infrared sensor receivers.
